(19) United States
(12) Patent Application Publication
(10) Pub. No.: US 2007/0121490 A1
(43) Pub. Date: May 31, 2007

(54) Cluster system, load balancer, node reassigning method and recording medium storing node reassigning program

(75) Inventors: Akinori Iwakawa, Kawasaki (JP); Satoshi Okuyama, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/391,368

(22) Filed: Mar. 29, 2006

(30) Foreign Application Priority Data
Nov. 30, 2005 (JP) 2005-347071

(51) Int. Cl. H04J 3/14; H04J 1/16

(52) U.S. Cl. 370/218; 370/235

(57) ABSTRACT

Each of node servers provided in a cluster system connected to load balancers includes a storage portion for storing node-session information that associates a session ID and a node server in charge with each other and node life/death information, a node checking portion for, when receiving a message sent from any one of the load balancers, judging whether or not a node server in charge of the session of the message is functioning normally, and a node reassigning portion for updating the node-session information so that the node server in charge of the session is changed to an alternative node server and sending data indicating the alternative node server to a load balancer different from the load balancer that has sent the message. This allows the cluster system to process messages from a plurality of load balancers efficiently even when the node server is not functioning normally.

### BACKGROUND OF THE INVENTION

1. Field of the Invention

The present invention relates to a cluster system having a plurality of node servers for processing requests that are made by user terminals and distributed by load balancers. In particular, the present invention relates to a cluster system connected to a plurality of load balancers having different communication protocols, a load balancer, a node reassigning method and a node reassigning program used in the cluster system.

2. Description of Related Art

IT (information technology) systems serving as economic and social infrastructures are required to have stability, robustness and economical efficiency. In order to ensure a high stability in the IT systems, there are several methods in which plural sets of systems are prepared, and when a trouble occurs or a maintenance is done in one of the systems, the systems are switched promptly. One of these methods is clustering.

FIG. 14 schematically shows a configuration of a WWW system utilizing the clustering. A WWW system 90 shown in FIG. 14 includes node servers 91a, 91b and 91c that are connected to each other. The node servers 91a, 91b and 91c have storage portions 92a, 92b and 92c, respectively. In each of the node servers 91a, 91b and 91c, an HTTP application is implemented. The WWW system 90 is connected to a load balancer 93. The load balancer 93 accepts HTTP messages from user terminals 94a and 94b and distributes them to the individual node servers in the WWW system 90.

For example, when the load balancer 93 assigns the HTTP message from the user terminal 94a to the node server 91a, an HTTP data communication is carried out between a browser provided in the user terminal 94a and the HTTP application provided in the node server 91a.

In the HTTP data communication, a series of data communications by operations conducted within one Web site by a user in the user terminal 94a are handled in a processing unit called a session. For example, in an electronic commerce site, the browser in the user terminal 94a and the HTTP application in the node server 91a handle a series of communications from log-in to log-out as one session. Information unique to each session is stored in the storage portion 92a of the node server 91a as session data.

Here, the session data in the data communication between the node server 91a and the user terminal 94a are duplicated and stored also in the storage portion 92b of the node server 91b and the storage portion 92c of the node server 91c. When the session data in the storage portion 92a of the node server 91a is updated, the session data in the storage portions 92b and 92c of the node servers 91b and 91c are also updated automatically.

In this way, even when the node server 91a stops functioning due to failure and a session is interrupted before the end of this session, the node server 91b or the node server 91c can take over that session using the session data in the storage portion 92b or 92c. The clustering is realized by the above-described combination of a session data duplication processing and a load distribution processing by the load balancer.

In recent years, there has been an emerging system of providing a service for interfacing communications according to a plurality of protocols. An example thereof is an SIP/HTTP application server that has a function of interfacing an SIP server and a WWW server. This SIP/HTTP application server has a function of, for example, creating an SIP protocol message for realizing clearing, holding, forwarding, etc. designated by a message sent from a user terminal according to an HTTP protocol, and sending this SIP protocol message to a terminal with a telephone function. This allows a user to conduct operations such as call origination from a Web page to a telephone, holding, forwarding and clearing a call from a Web page, for example.

FIG. 15 schematically shows a clustering configuration in an SIP/HTTP interfacing system 99 having a function of interfacing an SIP server and a WWW server. In the configuration shown in FIG. 15, two load balancers 93 and 97 are provided. The load balancer 93 carries out a communication according to the HTTP protocol, and the load balancer 97 carries out a communication according to the SIP protocol. In each of node servers 95a, 95b and 95c, an SIP/HTTP application having a function of interfacing an SIP protocol message and an HTTP protocol message is implemented.

In the SIP/HTTP interfacing system 99 shown in FIG. 15, for example, the load balancer 93 receives a message according to the HTTP protocol from a user terminal 94a and assigns it to any of the node servers 95a, 95b and 95c. For example, when the HTTP protocol message is assigned to the node server 95a, the SIP/HTTP application in the node server 95a creates an SIP message for executing a call processing corresponding to the received HTTP message and forwards it to the load balancer 97. The load balancer 97 forwards the SIP message to a user terminal 98a as a destination. In this manner, the data communication is carried out between the user terminal 94a and the user terminal 98a.

Information unique to each session between the users is duplicated and stored in storage portions 96a, 96b and 96c of the node servers 95a, 95b and 95c as the respective session data. Consequently, even when any of the node servers 95a, 95b and 95c stops functioning before the end of processing the session, the other node servers can take over this session.

In the case where a plurality of load balancers are present as shown in FIG. 15, it is preferable that the same session is processed by a single node server, in order to minimize overhead accompanying the duplication of sessions. In other words, for an efficient processing, messages regarding the same session from a plurality of load balancers are preferably assigned to a single node server. Furthermore, even when failure occurs in any of the node servers 95a, 95b and 95c, a plurality of load balancers have to operate such that the same session is processed by the same node server.

Several examples of exchanging information between a plurality of load balancers have been proposed in JP 2004-199678 A, JP 2003-174473 A, etc., for instance.

### SUMMARY OF THE INVENTION

However, the examples in JP 2004-199678 A and JP 2003-174473 A do not disclose any method for allowing the plurality of load balancers to distribute messages synchronously belonging to a plurality of related sessions to a single cluster node.

It is an object of the present invention to provide a cluster system, a load balancer, a node reassigning method and a node reassigning program that allows a plurality of load balancers to distribute messages synchronously belonging to the same session or a plurality of related sessions to a single cluster node in a data communication via the plurality of load balancers even when a node server stops functioning normally, thereby processing the messages from the plurality of load balancers efficiently.

A cluster system according to the present invention includes a plurality of node servers that are connected to a plurality of load balancers and process messages from a plurality of user terminals respectively accessing the plurality of load balancers so as to allow a data communication between the plurality of user terminals. Each of the plurality of node servers is accessible to a storage portion storing node-session information that associates a session ID for identifying a session, which is a series of data communications conducted by a same user terminal, and a node server in charge for processing a message belonging to the session identified by the session ID with each other, and node life/death information that indicates whether or not each of the plurality of node servers is functioning normally. Each of the plurality of node servers includes a node checking portion for, when receiving a message containing the session ID from any one of the plurality of load balancers, judging whether or not the node server in charge of the session identified by the session ID contained in the message is functioning normally using the node-session information and the node life/death information, and a node reassigning portion for, if the node checking portion judges that the node server in charge of the session is not functioning normally, updating the node-session information so that the node server in charge of the session is changed to an alternative node server and sending data indicating the session and data indicating the alternative node server to the plurality of load balancers.

The load balancers are load distribution servers that collectively manage messages from the user terminals and forward the messages to the plurality of node servers.

The session refers to, in the data communication between a plurality of user terminals respectively accessing a plurality of load balancers, a concept representing a series of the data communications conducted by the same user terminal.

The storage portion stores the node-session information associating the session ID for identifying each session and the node server in charge of each session with each other. Thus, the node checking portion can specify a node server in charge of the session of the message received from the load balancer using the node-session information. Furthermore, the node checking portion can judge whether or not the node server in charge of the session of the message is functioning normally based on the node-session information. As a result, in the case where the node server in charge is not functioning normally due to a failure or the like, for example, the node checking portion detects abnormality of the node server in charge. In other words, it is detected that the node server in charge of the above-noted session has to be reassigned.

Since the node reassigning portion sends the data indicating an alternative node server to function instead of the node server in charge that is not functioning normally and the session of which the alternative node server is in charge to the plurality of load balancers, the load balancer that receives these data can obtain information that the node server in charge of the session has been changed. In other words, the plurality of load balancers are notified of the reassignment of the node server. Accordingly, even in the case where one of the plurality of node servers stops functioning normally and its function is switched to an alternative node server, the plurality of load balancers can access the switched alternative node server. As a result, in a data communication via a plurality of load balancers, even in the case where a part of a plurality of node servers stops functioning normally, the plurality of load balancers can distribute messages synchronously belonging to the same session or a plurality of related sessions to the same node server. In other words, it is possible to achieve a cluster system capable of processing messages from a plurality of load balancers efficiently even when a part of a plurality of node servers stops functioning normally.

A node reassigning method according to the present invention is a node reassigning method conducted by a plurality of node servers that are connected to a plurality of load balancers and process messages from a plurality of user terminals respectively accessing the plurality of load balancers so as to allow a data communication between the plurality of user terminals in a cluster system including the plurality of node servers. The method includes an operation in which each of the plurality of node servers stores node-session information that associates a session ID for identifying a session, which is a series of data communications conducted by a same user terminal, and a node server in charge for conducting a processing regarding the session identified by the session ID with each other, and node life/death information that indicates whether or not each of the plurality of node servers is functioning normally, a node checking operation in which, when receiving a message sent from any one of the plurality of load balancers, any one of the plurality of node servers judges whether or not the node server in charge of the session of the message is functioning normally using the node-session information and the node life/death information, and a node reassigning operation in which, if the node server in charge of the session is judged not to be functioning normally in the node checking operation, the node server updates the node-session information so that the node server in charge of the session is changed to an alternative node server and sends the session ID of the session and data indicating the alternative node server to the plurality of load balancers.

A node reassigning program stored in a recording medium according to the present invention is a node reassigning program causing a plurality of node servers that are connected to a plurality of load balancers and process messages from a plurality of user terminals respectively accessing the plurality of load balancers so as to allow a data communication between the plurality of user terminals in a cluster system including the plurality of node servers to execute processes below. The processes include a process of storing in a storage portion of the node server node-session information that associates a session ID for identifying a session, which is a series of data communications conducted by a same user terminal, and a node server in charge for conducting a processing regarding the session identified by the session ID with each other, and node life/death information that indicates whether or not each of the plurality of node servers is functioning normally, a node checking process of, when receiving a message sent from any one of the plurality of load balancers, judging whether or not the node server in charge of the session of the message is functioning normally using the node-session information and the node life/death information, and a node reassigning process of, if the node server in charge of the session is judged not to be functioning normally in the node checking process, updating the node-session information so that the node server in charge of the session is changed to an alternative node server and sending the session ID of the session and data indicating the alternative node server to the plurality of load balancers.

In accordance with the present invention, it is possible to provide a cluster system, a load balancer, a node reassigning method and a node reassigning program that allows a plurality of load balancers to distribute messages belonging to a single session or a plurality of related sessions to a single cluster node in a data communication via the plurality of load balancers even when a node server stops functioning normally, thereby processing the messages efficiently.

### BRIEF DESCRIPTION OF THE DRAWINGS

FIG. 1 is a functional block diagram showing a configuration of a cluster system in Embodiment 1.

FIG. 2 is a functional block diagram showing an example of a configuration of a node server 2a.

FIG. 3 is a functional block diagram showing an example of a configuration of an HTTP load balancer 5a.

FIG. 4 shows an example of a configuration of session data.

FIG. 5A shows an example of node-session information stored in a storage portion 6a of the HTTP load balancer 5a, and FIG. 5B shows an example of node-session information stored in a storage portion 6b of an SIP load balancer 5b.

FIG. 6 shows an example of a data structure of node life/death information.

FIG. 7A shows an example of a table of sessions in node-session information in a storage portion 3a, and FIG. 7B shows an example of a table of nodes in charge in the node-session information in the storage portion 3a.

FIG. 8 is a flowchart showing an example of an operation of the node server 2a.

FIG. 9 is a flowchart showing an example of details of a node reassigning processing.

FIG. 10 is a flowchart showing an example of a processing in which the HTTP load balancer 5a receives an HTTP message from a user terminal 7a and sends the HTTP message to a cluster system 1.

FIG. 11 is a flowchart showing an example of a processing in which the HTTP load balancer 5a receives the HTTP message from a node server.

FIG. 12 is a flowchart showing an example of an operation of the node server 2a in Embodiment 2.

FIG. 13 is a flowchart showing an example of a processing in which the SIP load balancer 5b receives an SIP message from a user terminal 8a and sends the SIP message to the cluster system 1 in Embodiment 2.

FIG. 14 schematically shows a configuration of a WWW system utilizing clustering.

FIG. 15 schematically shows a clustering configuration in an SIP/HTTP interfacing system having a function of interfacing an SIP server and a WWW server.

### DETAILED DESCRIPTION OF THE INVENTION

In the cluster system according to the present invention, it is preferable that, after an access regarding the session is made to the node server from a load balancer different from the load balancer that has sent the message, the node reassigning portion sends the session ID identifying the session and the data indicating the alternative node server to the load balancer that has made the access.

The load balancer that makes an access regarding the session to the node server is a load balancer handling that session. Thus, the node reassigning portion can send the load balancer handling that session the session ID of the session and the data indicating the alternative node server according to the timing of that access. As a result, it is possible to send the session ID and the data efficiently to the load balancer handling the above-noted session.

The cluster system according to the present invention includes a plurality of node servers that are connected to a plurality of load balancers conducting data communications according to different communication protocols and process messages from a plurality of user terminals having different communication protocols respectively accessing the plurality of load balancers so as to allow the data communications between the plurality of user terminals having different communication protocols. Each of the plurality of node servers is accessible to a storage portion storing node-session information that associates a session ID for identifying a session, which is a series of data communications conducted between user terminals having different communication protocols, and a node server in charge for conducting a processing regarding the session identified by the session ID with each other, and node life/death information that indicates whether or not each of the plurality of node servers is functioning normally. Each of the plurality of node servers includes a node checking portion for, when receiving a message containing the session ID sent from any one of the plurality of load balancers, judging whether or not the node server in charge of the session of the session ID contained in the message is functioning normally using the node-session information and the node life/death information, and a node reassigning portion for, if the node checking portion judges that the node server in charge of the session is not functioning normally, updating the node-session information so that the node server in charge of the session is changed to an alternative node server and sending the session ID of the session and data indicating the alternative node server to another load balancer having a different communication protocol from the load balancer that has sent the message.

Since the node reassigning portion sends the data indicating the alternative node server and the session ID of the session of which the alternative node server is in charge to another load balancer having a different communication protocol from the load balancer that has sent the message, it is possible to notify the load balancer having the different protocol of the alternative node server when the node server in charge of the session has been reassigned to the alternative node server. As a result, in a data communication via a plurality of load balancers having different communication protocols, even when a part of a plurality of node servers stops functioning normally, it is possible to achieve a cluster system capable of processing messages from the plurality of load balancers having different communication protocols efficiently.

In the cluster system according to the present invention, the plurality of load balancers can include a load balancer for conducting a data communication according to an HTTP protocol and a load balancer for conducting a data communication according to an SIP protocol.

The load balancer according the present invention is the load balancer connected to the cluster system according to the present invention and includes a storage portion for storing node-session information that associates a session ID and a node server in charge for conducting a processing regarding a session identified by the session ID with each other, a load distributing portion for receiving a message from the plurality of user terminals, acquiring the session ID from the message and assigning the message to a node server determined based on the session ID and the node-session information, and an updating portion for, when the session ID of the session and the data indicating the alternative node server are sent from the node reassigning portion provided in the node server, updating the node-session information stored in the storage portion based on both the data that are sent.

Since the load distributing portion determines a node server to which a message is to be assigned based on the node-session information, messages of the same session are assigned to a single node server. Also, since the node-session information in the storage portion is updated by the updating portion based on information from the node reassigning portion provided in the node server, the node-session information is updated by the information indicating an alternative node server in charge of the session even in the case where the node server in charge of the session stops functioning normally. Accordingly, even when any of the node servers in the cluster system stops functioning normally, the load balancer can access the alternative node server and assign the same session to a single node server.

The following is a detailed description of embodiments of the present invention, with reference to the accompanying drawings.

### Embodiment 1

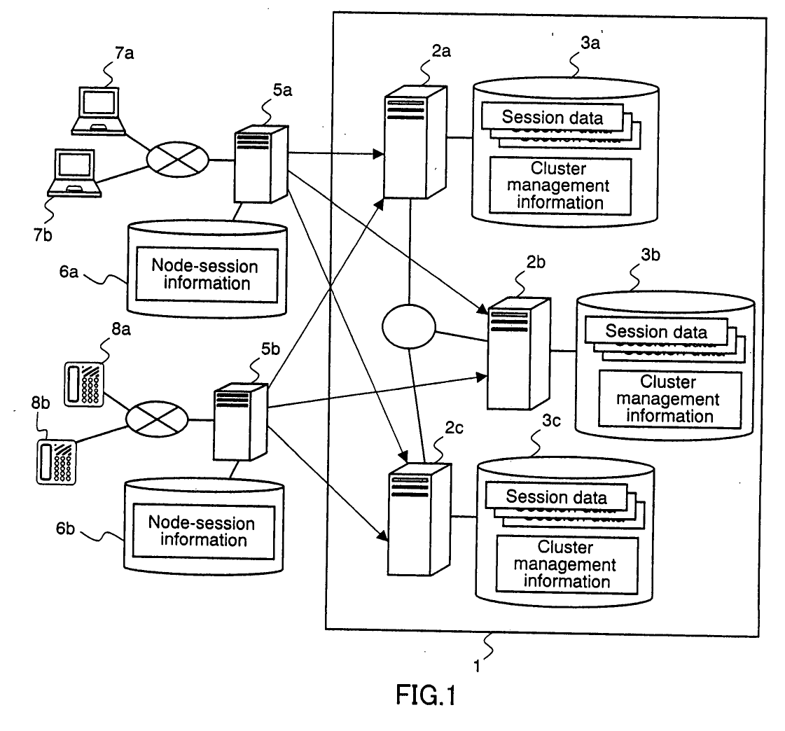

FIG. 1 is a functional block diagram showing a configuration of a cluster system in the present embodiment. A cluster system 1 shown in FIG. 1 has an exemplary configuration of clustering an SIP/HTTP interfacing system having a function of interfacing an SIP server and a WWW server.

Although different load balancers are constituted by one HTTP load balancer and one SIP load balancer in this configuration, they also may be constituted by a plurality of HTTP load balancers and a plurality of SIP load balancers, may be constituted by HTTP or SIP load balancers alone, or may be load balancers handling a protocol other than HTTP and SIP.

The cluster system 1 shown in FIG. 1 includes node servers 2a, 2b and 2c that are connected to each other. The node servers 2a, 2b and 2c have storage portions 3a, 3b and 3c, respectively. The storage portions 3a, 3b and 3c store session data and cluster management information.

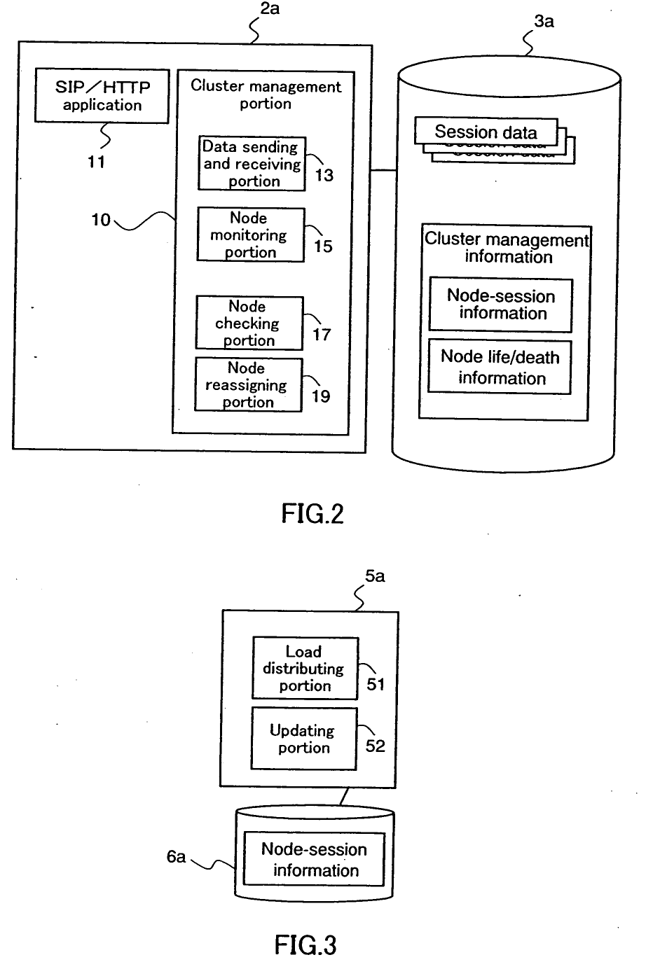

FIG. 2 is a functional block diagram showing an example of a configuration of the node server 2a. It should be noted that the node servers 2b and 2c can have a configuration similar to that shown in FIG. 2. As shown in FIG. 2, the node server 2a includes an SIP/HTTP application executing portion 11 and a cluster management portion 10. The cluster management portion 10 includes a data sending and receiving portion 13, a node monitoring portion 15, a node checking portion 17 and a node reassigning portion 19. The node server 2a can access the storage portion 3a. The cluster management information stored in the storage portion 3a includes node-session information (information about a node in charge of a session) and node life/death information.

Referring to FIG. 1 again, the cluster system 1 is connected to an HTTP load balancer 5a and an SIP load balancer 5b. The HTTP load balancer 5a is connected to a plurality of user terminals 7a and 7b via a network. The user terminals 7a and 7b are, for example, computers in which a Web browser for an HTTP communication is implemented, or the like. The SIP load balancer 5b is connected to a plurality of user terminals 8a and 8b via a network. The user terminals 8a and 8b are, for example, telephone sets for an SIP communication, or the like.

FIG. 3 is a functional block diagram showing an example of a configuration of the HTTP load balancer 5a. As shown in FIG. 3, the HTTP load balancer 5a includes a load distributing portion 51 and an updating portion 52. The HTTP load balancer 5a can access a storage portion 6a. The storage portion 6a stores node-session information. It should be noted that the SIP load balancer 5b also has a configuration similar to that shown in FIG. 3.

The node servers 2a, 2b and 2c, the HTTP load balancer 5a and the SIP load balancer 5b are configured by, for example, a personal computer or a computer of a server or the like. The functions of the SIP/HTTP application executing portion 11 and the cluster management portion 10 in the node servers 2a, 2b and 2c and the load distributing portion 51 and the updating portion 52 in the HTTP load balancer 5a can be achieved by an execution of a predetermined program by a CPU or an MPU of the computer. Also, the storage portions 3a, 3b, 3c, 6a and 6b can be a hard disk, a semiconductor memory, a flexible disk, a DVD or the like provided in the computer.

The load distributing portion 51 in the HTTP load balancer 5a accepts a message based on an HTTP protocol (in the following, referred to as an HTTP message) from the user terminals 7a and 7b and assigns it to each of the node servers 2a, 2b and 2c in the cluster system 1. The SIP/HTTP application executing portion 11 in each of the node servers 2a, 2b and 2c that has received the HTTP message from the HTTP load balancer 5a, for example, creates an SIP message for executing a call processing corresponding to the received HTTP message and sends it to the user terminal 8a or 8b via the SIP load balancer 5b.

The load distributing portion in the SIP load balancer 5b accepts a message based on an SIP protocol (in the following, referred to as an SIP message) from the user terminals 8a and 8b and assigns it to each of the node servers 2a, 2b and 2c in the cluster system 1. The SIP/HTTP application executing portion 11 in each of the node servers 2a, 2b and 2c that has received the SIP message from the SIP load balancer 5b, for example, updates call state information stored in HTTP session data corresponding to the received SIP message. Incidentally, due to the characteristics of the HTTP protocol, the above-noted updated call state information is not sent to the side of the user terminal 7a at the time when the SIP message is received, but is sent thereto as a response to the next HTTP message.

In this manner, the data communications can be carried out between the user terminal 7a and the user terminal 8b having different communication protocols, for example. Here, a series of the data communications between the user terminal 7a and the user terminal 8b is handled in a processing unit called a session, for example. The session is a concept representing a series of data communications between the same user terminals. Hereinafter, the session in the present embodiment will be described.

(Description of the Session)

One session includes, for example, all the processings of accesses from user terminals in data communications between these user terminals processed in the SIP/HTTP application executing portion 11. For example, in the case where a call is originated from a Web browser of the user terminal 7a to the user terminal 8b, a session starts at the time of call origination and ends when the conversation is disconnected. In this case, all the accesses from the user terminal 7a and the user terminal 8b from the time of call origination until the conversation is disconnected are included in one session. This session is referred to as an integrated session.

Further, the integrated session includes an HTTP session and an SIP session. The HTTP session is a series of data communications by the same user between the user terminal 7a or 7b and the node server 2a, 2b or 2c, namely, a series of data communications by the same user according to the HTTP protocol. The SIP session is a series of data communications by the same user between the user terminal 8a or 8b and the node server 2a, 2b or 2c, namely, a series of data communications by the same user according to the SIP protocol.

An HTTP session ID is, for example, generated when the user terminal 7a accesses a Web site for the first time and contained in an HTTP message that is sent to the node server 2a at the time of the first access. For example, in the case where the node server 2a has received this HTTP message, the node server 2a generates a pair of the HTTP session ID and the integrated session ID and records this association in a table. Furthermore, in the case where the node server 2a creates the SIP message for executing the call processing associated with the received HTTP message and sends it to the user terminal 8a via the SIP load balancer 5b, for example, the node server 2a generates the SIP session ID, records it in association with the integrated session ID, and further includes the SIP session ID in the SIP message and sends it.

Thereafter, in a series of data communications between the node server 2a and the user terminal 8a, the SIP message exchanged via the SIP load balancer 5b contains the SIP session ID. Also, in a series of data communications between the node server 2a and the user terminal 7a, the HTTP message exchanged via the HTTP load balancer 5a contains the HTTP session ID.

In this way, the integrated session ID generated in the node server 2a serves to associate the SIP session ID and the HTTP session ID with each other. Until a series of data communications between the user terminal 7a and the user terminal 8a ends, the integrated session ID is retained in the node server 2a.

The integrated session ID generated in the node servers 2a, 2b and 2c is stored in the storage portion 3a, 3b and 3c of the respective node servers 2a, 2b and 2c as session data together with session information used in the session, for example.

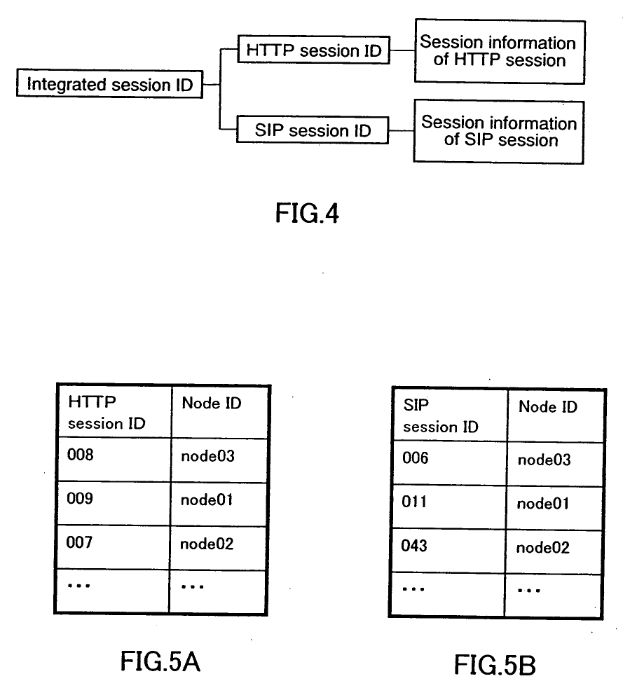

FIG. 4 shows an example of a configuration of the session data. In the example illustrated by FIG. 4, the HTTP session ID and the SIP session ID are associated with the integrated session ID. The session information of the HTTP session is associated with the HTTP session ID, and the session information of the SIP session is associated with the SIP session ID. The session information set to the HTTP session is, for example, an address, a name, etc. inputted by the user terminals 7a and 7b, and the session information of the SIP session is, for example, a telephone number of a caller, a telephone number of a call destination, etc.

The session data are generated by the SIP/HTTP application executing portion when any one of the node servers 2a, 2b and 2c receives a message requesting a start of a series of data communications from the user terminal, for example. The session data are duplicated and stored in the respective storage portions 3a, 3b and 3c of the node servers 2a, 2b and 2c. When any one of the session data stored in the storage portions 3a, 3b and 3c is updated, the other session data are updated as well. In this manner, the contents of the session data stored in the storage portions 3a, 3b and 3c are always kept the same.

Thus, even when any one of the node servers 2a, 2b and 2c comes to a halt due to failure during a processing of a certain session before the end of that session, the other node servers can take over that session because the session data are kept in the storage portions of the other node servers.

The above description has been directed to the session. In the cluster system 1 shown in FIG. 1, the same integrated sessions are processed by a single node server. In other words, the HTTP load balancer 5a and the SIP load balancer 5b assign the HTTP session and the SIP session belonging to the same integrated session to a single node server. Accordingly, for example, the HTTP load balancer 5a and the SIP load balancer 5b respectively store in the storage portions 6a and 6b node-session information in which the HTTP/SIP session ID is associated with the node ID identifying the node server in charge of the integrated session identified by that HTTP/SIP session ID.

The node-session information stored in the HTTP load balancer 5a and the SIP load balancer 5b is data indicating which session should be assigned to which node server. FIG. 5A shows an example of the node-session information stored in the storage portion 6a of the HTTP load balancer 5a.

In the example illustrated by FIG. 5A, the HTTP session ID and the node ID are associated with each other and stored. The load distributing portion 51 in the HTTP load balancer 5a finds, from the node-session information in the storage portion 6a, an HTTP session ID that matches the HTTP session ID contained in the HTTP message received from the user terminal and acquires a node ID associated with that HTTP session ID, for example. The load distributing portion 51 sends the HTTP message to the node server identified by the acquired node ID.

FIG. 5B shows an example of the node-session information stored in the storage portion 6b of the SIP load balancer 5b. In the example illustrated by FIG. 5B, the SIP session ID and the node ID are associated with each other and stored. The load distributing portion in the SIP load balancer 5b finds, from the node-session information in the storage portion 6b, an SIP session ID that matches the SIP session ID contained in the SIP message received from the user terminal and acquires a node ID associated with that SIP session ID. The load distributing portion in the SIP load balancer 5b sends the SIP message to the node server identified by the acquired node ID.

Next, the cluster management portion 10 shown in FIG. 2 will be described. The data sending and receiving portion 13 executes mirroring of the session data and the cluster management information stored in the storage portions 3a, 3b and 3c in the respective node servers 2a, 2b and 2c, as necessary. In this manner, the contents of the data stored in the storage portions 3a, 3b and 3c in the respective node servers 2a, 2b and 2c are synchronized. In other words, the respective node servers 2a, 2b and 2c can always share the same contents of the session data and cluster management information with each other.

It should be noted that the configuration for allowing the respective node servers 2a, 2b and 2c to always share the same contents of the session data and cluster management information with each other is not limited to the method of synchronizing the data contents described above. For example, a separate storage portion shared by the respective node servers 2a, 2b and 2c also can be provided.

The node monitoring portion 15 in the node server 2a and those in the other node servers 2b and 2c monitor each other for whether or not the node servers are functioning normally. For example, a signal called a Heart-Beat signal can be exchanged among the node servers 2a, 2b and 2c, thereby checking whether or not the functions of the other node servers are alive. When detecting that the other node server is not functioning normally, namely, detecting the failure of the other node server, the node monitoring portion 15 updates the node life/death information and records that the node server experiencing the failure is not functioning normally in the storage portion 3a.

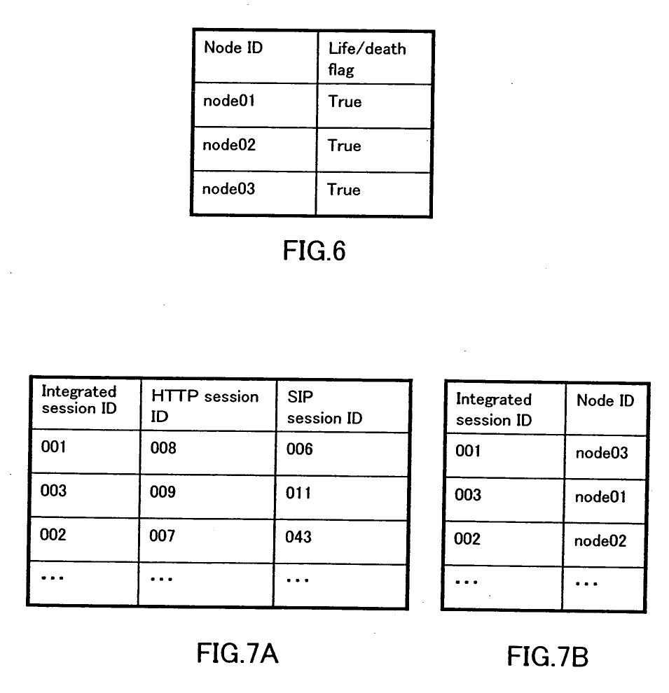

FIG. 6 shows an example of a data structure of the node life/death information. In the example illustrated by FIG. 6, a life/death flag is recorded for each node ID. For example, the node server that has detected that the node server with a node ID=“node01” is not functioning normally updates the life/death flag of the node ID=“node01” to “false”, thereby recording that the function of the node server with the node ID=“node01” is at a halt.

The node checking portion 17 refers to the node-session information and the node life/death information in the storage portion 3a and judges whether or not the node server in charge of a processing of a predetermined session is functioning normally.

For example, in the case where the node server 2b among the node servers 2a, 2b and 2c is at a halt due to failure, the HTTP load balancer 5a sends the HTTP message of the session of which the node server 2b is in charge to the node server 2b but an error processing result returns, and thus sends that HTTP message to the other node server (for example, the node server 2a). In this way, there are some cases where the node server 2a receives the HTTP message regarding a session that is different from the session of which the node server 2a itself is in charge. For example, in the case where the node server 2a receives a message of the session of which the node server 2b is in charge, the node checking portion 17 in the node server 2a judges whether or not the node server 2b is functioning normally.

FIG. 7 shows an example of the node-session information stored in the storage portion 3a. In the example illustrated by FIG. 7, the node-session information is constituted by a table of sessions in which the integrated session ID, the SIP session ID and the HTTP session ID are associated with each other (see FIG. 7A) and a table of nodes in charge in which the integrated session ID and the node ID are associated with each other (see FIG. 7B). The above-described information is generated and stored when the node server 2a receives the HTTP message or the SIP message of starting the data communication from the user terminal, for example.

The node checking portion 17, for example, finds an HTTP session ID that matches the HTTP session ID contained in the received HTTP message from the table of sessions in the node-session information shown in FIG. 7A and acquires an integrated session ID associated with that HTTP session ID. The node checking portion 17 finds an integrated session ID that matches the acquired integrated session ID from the table of nodes in charge in the node-session information shown in FIG. 7B and acquires a node ID associated with that integrated session ID. Furthermore, the node checking portion 17 finds a node ID that matches the acquired node ID from the node life/death information (see FIG. 6) and refers to a life/death flag associated with that node ID, thereby judging whether the node server in charge of the session of the received HTTP message is alive or dead.

The node reassigning portion 19 updates the node-session information in the storage portion 3a and sends the updated node-session information to the HTTP load balancer 5a or the SIP load balancer 5b. An updating portion of the HTTP load balancer 5a or the SIP load balancer 5b updates the node-session information stored in the storage portion 6a or 6b based on the received node-session information.

In the node-session information stored in the storage portion 3a, for example, the node reassigning portion 19 changes a predetermined node ID to a node ID of an alternative node server, thereby updating the node-session information. In this case, the node reassigning portion 19 sends the changed node ID and an SIP session ID or an HTTP session ID associated therewith to the SIP load balancer 5b or the HTTP load balancer 5a as the node-session information.

An updating portion 52 of the HTTP load balancer 5a that has received the node ID changed by the node reassigning portion 19 and the HTTP session ID associated therewith updates the node-session information stored in the storage portion 6a based on the received node ID and HTTP session ID. For example, the updating portion 52 changes a node ID associated with that HTTP session ID to the received node ID.

An updating portion of the SIP load balancer 5b that has received the node ID changed by the node reassigning portion 19 and the SIP session ID associated therewith similarly updates the node-session information stored in the storage portion 6b based on the received node ID and SIP session ID. For example, the above-mentioned updating portion changes a node ID associated with the received SIP session ID to the received node ID.

Incidentally, although the cluster system shown in FIG. 1 has three node servers, the number of the node servers is not limited to three. Also, the number of the user terminals shown in FIG. 1 is smaller than reality for the convenience of description.

(Exemplary Operation of the Node Server 2a)

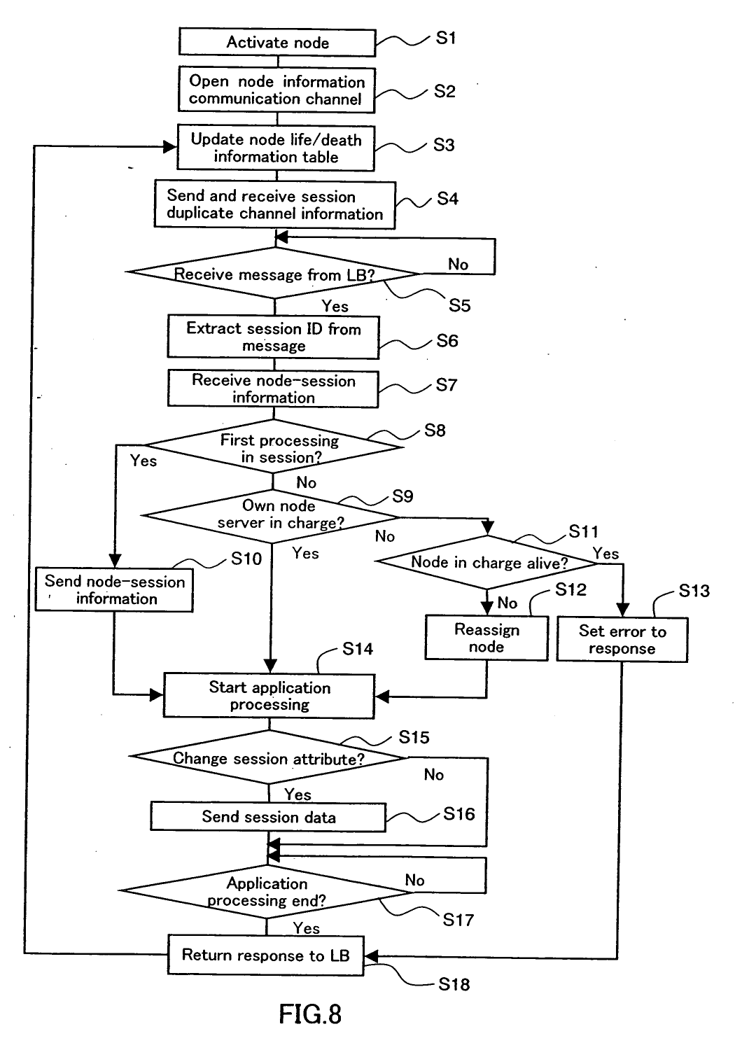

Now, the operation of the node server 2a will be described. FIG. 8 is a flowchart showing an exemplary operation of the node server 2a. It should be noted that the operations of the node servers 2b and 2c are similar to that shown in FIG. 8.

As shown in FIG. 8, when the node server 2a is activated (Step S1), the data sending and receiving portion 13 opens a node information communication channel (Step S2). The node information communication channel is, for example, a channel for synchronizing the data stored in the storage portions 3a, 3b and 3c of the node servers 2a, 2b and 2c. The data sending and receiving portions 13 in the node servers 2a, 2b and 2c send and receive the data among the node servers 2a, 2b and 2c using the node information communication channel.

The data sending and receiving portion 13 sends and receives the node life/death information with respect to the other node servers 2b and 2c and updates the node life/death information in the storage portion 3a (Step S3). Also, the data sending and receiving portion 13 sends and receives a session duplicate channel information with respect to the other node servers 2b and 2c (Step S4). Incidentally, it is preferable that the session duplicate channel information is sent and received periodically.

The SIP/HTTP application executing portion 11 waits until it receives a message from the HTTP load balancer 5a or the SIP load balancer 5b (abbreviated as LB in FIG. 8) (Step S5). On receipt of the message, the SIP/HTTP application executing portion 11 extracts the SIP session ID or the HTTP session ID from the received message, refers to the table of sessions in the node-session information (see FIG. 7A) and acquires the session ID (Step S6). The data sending and receiving portion 13 sends and receives the node-session information with respect to the other node servers 2b and 2c and updates the node-session information in the storage portion 3a to the latest information (Step S7).

The SIP/HTTP application executing portion 11 judges whether or not the received message is the first message in the session (Step S8) and, if it is, updates the node-session information in the storage portion 3a so that the own node server 2a becomes in charge of the session of the received message, and sends the updated node-session information to the other node servers 2b and 2c (Step S10). Thereafter, the SIP/HTTP application executing portion 11 starts an application processing according to the received message (Step S14).

Examples of the application processing include a processing for achieving a call originating function from a Web page. For example, an execution of forwarding and holding in the case of receiving the HTTP message and an update of call state information in the case of receiving the SIP message, etc. are carried out as the application processing.

If the received message is not the first message in the session (No in Step S8), the SIP/HTTP application executing portion 11 judges whether or not the own node server 2a is in charge of the session of the received message, with reference to the node-session information in the storage portion 3a (Step S9).

If the own node server 2a is in charge of the session of the received message, the SIP/HTTP application executing portion 11 starts the application processing (Step S14). The node server 2a is judged not to be in charge of the session of the received message, for example, in the following case.

The HTTP load balancer 5a usually sends the HTTP message to the node server in charge of the integrated session to which the HTTP message belongs. Therefore, the HTTP message received by the node server is the HTTP message of the integrated session of which the own node server 2a is in charge. However, in the case where the node server to which the HTTP load balancer 5a has sent the HTTP message is at a halt due to a failure, for example, the HTTP load balancer 5a resends the HTTP message to another node server. The node server receiving this HTTP message receives the HTTP message of the integrated session of which the own node server is not in charge. In such a case, in Step S9, the own node server 2a is judged not to be in charge of the integrated session of the received message.

If the own node server 2a is not in charge of the integrated session of the received HTTP message (No in Step S9), the node checking portion 17 judges whether or not the node server in charge of the above-noted session is functioning normally (Step S11). In this way, it is judged whether or not the HTTP message of the integrated session of which the own node server 2a is not in charge has been sent because the node server in charge of the integrated session is at a halt.

If the node server in charge is not functioning normally, the node reassigning portion 19 performs a node reassigning processing (Step S12). In other words, since the node server in charge is judged to be at a halt due to a failure or the like, a processing of switching the node server in charge of the above-noted integrated session to an alternative node server is carried out. Details of the node reassigning processing will be described later.

If the node server in charge is functioning normally, the node reassigning portion 19 sets an error to a response (Step S13). The SIP/HTTP application executing portion 11 returns the response to which the error is set to the HTTP load balancer 5a that is the sender of the HTTP message. The HTTP load balancer 5a that has received this response determines that the destination of the HTTP message was wrong.

After the application processing starts (Step S14), when the SIP/HTTP application executing portion 11 changes information used in the integrated session, namely, a session attribute (Yes in Step S15), the session data in the storage portion 3a are updated. The data sending and receiving portion 13 sends the updated session data to the other node servers 2b and 2c (Step S16). In this way, the session data in the storage portions 3b and 3c in the node servers 2b and 2c are also updated similarly to the session data in the storage portion 3a.

When the application processing ends (Yes in Step S17), the SIP/HTTP application executing portion 11 returns a response indicating a normal end to the HTTP load balancer 5a that is the sender of the message (Step S18). The above-described processing is repeated every time the node server 2a receives a message.

It should be noted that the processing of the node server 2a is not limited to that shown by the flowchart of FIG. 8. For example, the update of the node life/death information table (Step S3) and the sending and receiving of the session channel information (Step S4) do not have to be executed at the timing shown in FIG. 8 but may be executed as necessary.

(Example of the Node Reassigning Processing)

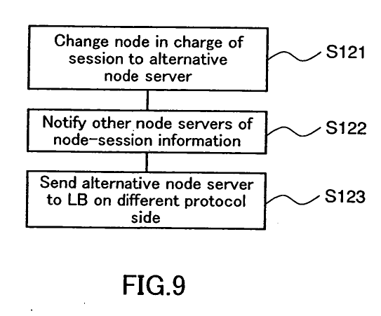

Here, an example of the node reassigning processing will be described. FIG. 9 is a flowchart showing details of the node reassigning processing (Step S12 in FIG. 8). The node reassigning processing shown in FIG. 9 is an example of a node reassigning processing executed when the node server 2a receives the HTTP message from the HTTP load balancer 5a. The node reassigning processing shown here is a processing of reassigning the integrated session that has been processed by the node server halted due to a failure to the node server 2a.

First, the node reassigning portion 19 in the node server 2a updates the integrated node-session information in the storage portion 3a so that the own node server 2a becomes in charge of the integrated session of the received HTTP message, for example (Step S121). In other words, the own node server 2a is made to be an alternative node server.

The node reassigning portion 19 finds an HTTP session ID that matches the HTTP session ID contained in the received HTTP message from the table of sessions (see FIG. 7A) in the node-session information in the storage portion 3a and acquires an integrated session ID associated with that HTTP session ID, for example. Then, the node reassigning portion 19 updates a node ID in charge of that integrated session ID described in the table of nodes in charge (see FIG. 7B) to the node ID of the own node server 2a. Incidentally, although an example in which the own node server 2a is the alternative node server is described here, not only the own node server 2a but also the other node servers functioning normally can be used as the alternative node server.

The data sending and receiving portion 13 notifies the other node servers 2b and 2c of the integrated session ID indicating the updated node ID and the integrated session to be updated (Step S122). In this way, the node-session information stored in the normally-functioning storage portion out of the storage portions 3b and 3c in the other node servers 2b and 2c is updated so as to indicate that the node server in charge of the session identified by the integrated session ID is the node server 2a.

The node reassigning portion 19 sends the updated node ID and the SIP session ID to the SIP load balancer 5b (Step S123). In other words, the node reassigning portion 19 sends the node ID and the SIP session ID indicating the alternative node server to the SIP load balancer 5b that carries out a data communication according to a protocol different from that of the HTTP load balancer 5a, which is the sender of the HTTP message received by the node server 2a.

On the other hand, when returning the response (Step S18 in FIG. 8), for example, the node ID indicating the alternative node server and the HTTP session ID are sent to the HTTP load balancer 5a. Thus, the node ID and the HTTP session ID or the SIP session ID are sent to both of the HTTP load balancer 5a and the SIP load balancer 5b. The node ID and the HTTP session ID or the SIP session ID that have been sent are stored in the respective storage portions 6a and 6b. As a result, the contents of the node-session information stored in the storage portion 6a in the HTTP load balancer 5a and that stored in the storage portion 6b in the SIP load balancer 5b match each other.

In other words, the HTTP session ID and the SIP session ID that are associated with the same integrated session ID are associated with the same node ID in charge. As a result, messages belonging to the HTTP session and the SIP session associated with the same integrated session are forwarded to the same node server.

In this manner, the HTTP load balancer 5a and the SIP load balancer 5b can allocate the HTTP message or the SIP message so that all the messages belonging to the session identified by the above-noted integrated session ID are processed by the node server 2a of the above-noted node ID.

Incidentally, in the above description, the node reassigning portion 19 sends the session reassigning information of which the load balancer is to be notified as a pair of the SIP/HTTP session ID and the node ID. However, it also may be possible to send a pair of the integrated session ID and the node ID. This configuration is made possible by providing the load balancers 5a and 5b with a mechanism of taking out the integrated session ID from the SIP/HTTP protocol message by a method of including the integrated session ID as it is in a part of the SIP/HTTP session ID. Further, in the case of adopting this configuration, the integrated session ID to which the message received by the node server belongs can be acquired directly without referring to the table of sessions shown in FIG. 7A.

(Exemplary Operation of the HTTP Load Balancer 5a when Receiving the Message from the User Terminal)

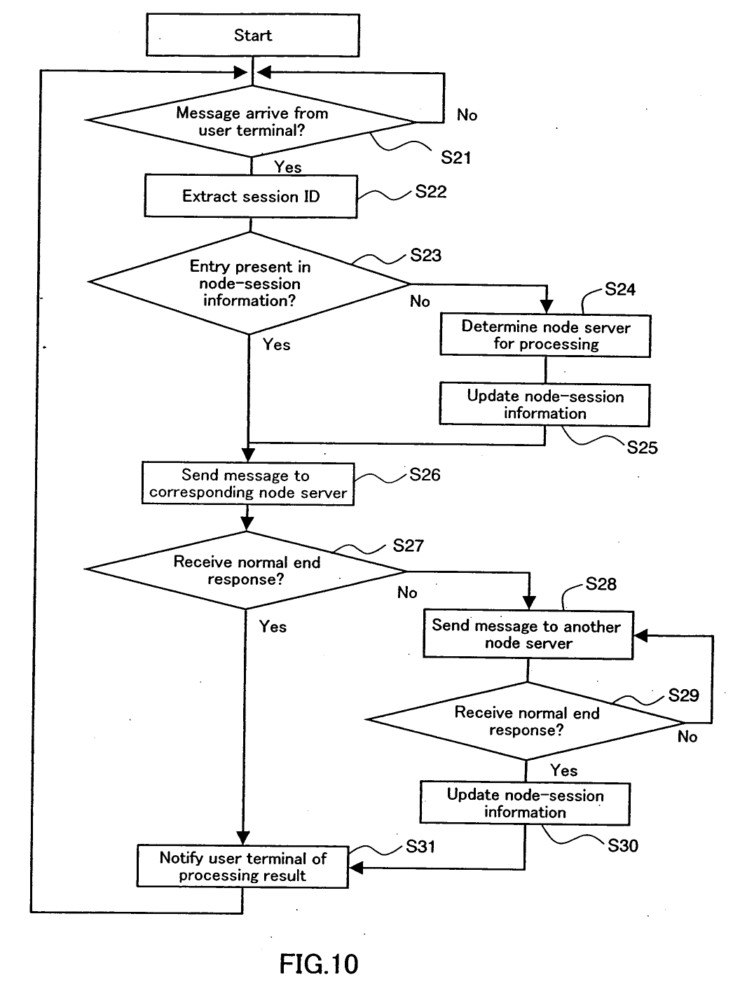

Now, the following is a description of an exemplary operation in the case where the HTTP load balancer 5a receives the HTTP message from the user terminal 7a. FIG. 10 is a flowchart showing an example of a processing in which the HTTP load balancer 5a receives the HTTP message from the user terminal 7a and sends the HTTP message to the cluster system 1.

On receipt of the HTTP message from the user terminal 7a (Step S21), the load distributing portion 51 in the HTTP load balancer 5a extracts the HTTP session ID contained in the HTTP message (Step S22).

The load distributing portion 51 judges whether or not an entry containing the extracted HTTP session ID is present in the node-session information in the storage portion 6a, for example (Step S23) and, if it is, sends the HTTP message to a node server identified by the node ID of that entry (Step S26). At this time, the load distributing portion 51 also may acquire an integrated session ID associated with the HTTP session ID from the node-session information in the storage portion 6a and add it to the HTTP message.

If the entry containing the HTTP session ID extracted in Step S22 is not present in the node-session information (No in Step S23), the load distributing portion 51 determines a node server as a destination, for example, at random (Step S24). The load distributing portion 51 registers the node ID of the determined node server in the node-session information in the storage portion 6a in association with the HTTP session ID (Step S25). The load distributing portion 51 sends the HTTP message to the node server determined in Step S24 (Step S26).

The load distributing portion 51 waits for a response from the node server to which the HTTP message has been sent and, on receipt of the response indicating a normal end, notifies the user terminal 7a of the processing result (Step S31), and again waits for an arrival of the HTTP message from the user terminal 7a or 7b.

For example, in the case where the node server to which the HTTP message has been sent is at a halt due to a failure, the load distributing portion 51 receives the response indicating an error (No in Step S27). In this case, the load distributing portion 51 changes a node server as a destination and sends the HTTP message to another node server (Step S28). The load distributing portion 51 repeats the processing of changing the node server as the destination and sending the HTTP message to another node server (Step S28) until it receives the response indicating the normal end. On receipt of the response indicating the normal end (Yes in Step S29), the load distributing portion 51 registers the node ID of the node server to which the HTTP message has been sent in the node-session information in the storage portion 6a in association with the HTTP session ID (Step S30).

Although not shown in the figure, in the case where the load distributing portion 51 only receives an error response even after repeating the processing of Step S28 predetermined times, it may end the repeating of Step S28 and notify the user terminal of the processing result indicating an error. Furthermore, the load distributing portion 51 may store information indicating whether or not the node server is functioning normally in the storage portion 6a and send the HTTP message only to the node server that is functioning normally.

In addition, an operation of the SIP load balancer 5b at the time of receiving a message from the user terminal can be similar to the processing shown in FIG. 10.

(Exemplary Operation of the HTTP Load Balancer 5a at the Time of Receiving a Message from the Node Server 2a)

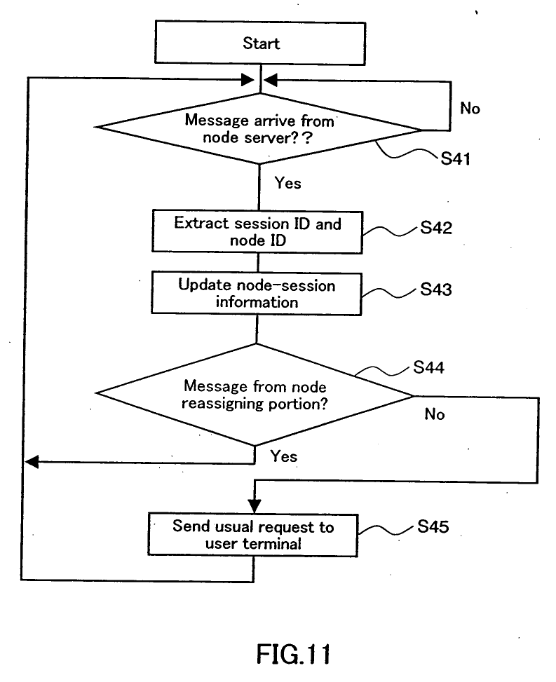

Now, the following is a description of an exemplary operation in the case where the HTTP load balancer 5a receives a message from a node server. FIG. 11 is a flowchart showing an example of a processing in which the HTTP load balancer 5a receives an HTTP message from a node server. Examples of the case in which the HTTP load balancer 5a receives a message from a node server include the case where the node reassigning portion 19 in the node server sends the node ID of an alternative node server and the HTTP session ID of the session of which the alternative node server is in charge to the HTTP load balancer 5a (Step S123 in FIG. 9).

On receipt of the message from the node server (Step S41), the HTTP load balancer 5a extracts an HTTP session ID and a node ID from the message (Step S42). Also, the updating portion 52 updates the node-session information in the storage portion 6a based on the extracted HTTP session ID and node ID (Step S43). For example, the updating portion 52 changes a node ID associated with the HTTP session ID extracted in Step S42 to the node ID extracted in Step S42.

If the HTTP session ID extracted in Step S42 is not present in the node-session information, the HTTP session ID and node ID extracted in Step S43 are newly registered.

If the received message is not a node reassigning notification from the node reassigning portion 19 in the node server (No in Step S44), the HTTP load balancer 5a sends a usual request to a client (Step S45).

It should be noted that a processing similar to that shown in FIG. 11 also can be carried out even when the SIP load balancer 5b receives a message from a node server.

### Embodiment 2

In Embodiment 1, at the time of the node reassigning processing (Step S12 in FIG. 8), the node reassigning portion 19 has notified a load balancer of the node ID and the HTTP/SIP session ID of the alternative node server (Step S123 in FIG. 9). In contrast, in the present embodiment, the node reassigning portion 19 makes the above-mentioned notification not at the time of the node reassigning processing but at the time when an access is made by a load balancer after the node reassigning processing as a redirect instruction in response to that access.

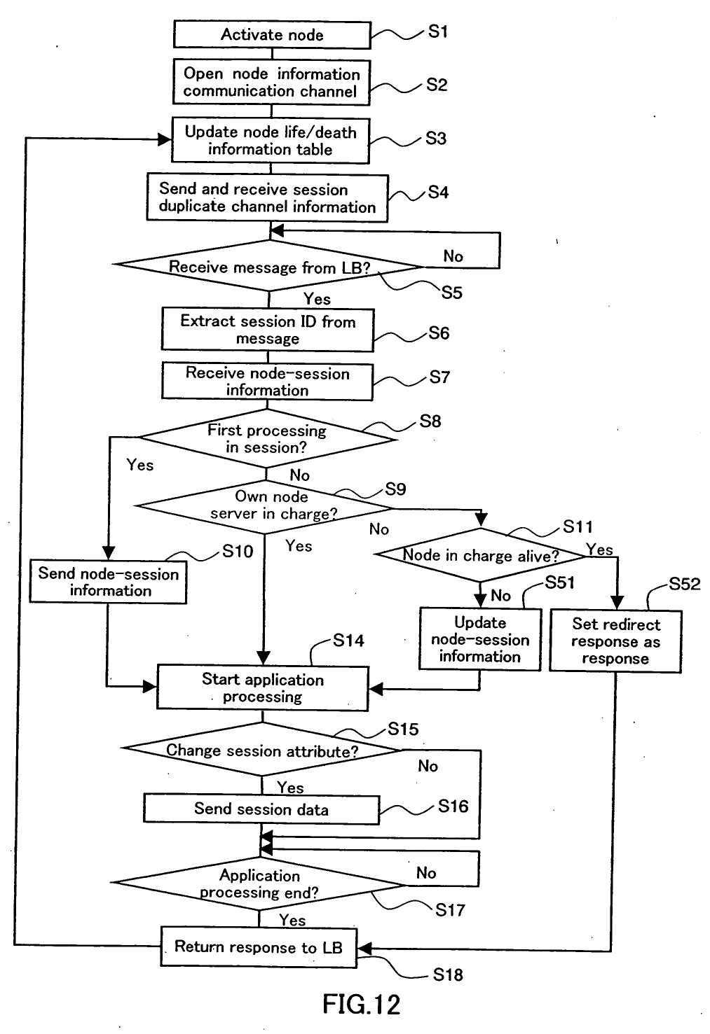

FIG. 12 is a flowchart showing an example of an operation of the node server 2a in the present embodiment. The processing shown in FIG. 12 is different from that shown in FIG. 8 in Step S51 and Step S52.

In Step S11, the node checking portion 17 judges whether or not the node server in charge of the session is functioning normally. If it is not functioning normally (No in Step S11), the node reassigning portion 19 updates the node-session information in the storage portion 3a so that the own node server 2a becomes the node server in charge of the session of the received message. Also, the data sending and receiving portion 13 notifies the other node servers 2b and 2c of the updated node-session information. In other words, the processings of Step S121 and Step S122 shown in FIG. 9 are executed.

Thus, in the case where the function of the node server in charge is at a halt due to a failure or the like, the node-session information is updated so that the node server in charge of the session is changed to an alternative node server.

If the node server in charge is functioning normally (Yes in Step S11), the SIP/HTTP application executing portion 11 pairs the node ID of that node server in charge and the HTTP/SIP session ID of the session so as to generate a redirect response, and sets it as a response (Step S52). The response as the redirect response is sent to the load balancer as the message sender.

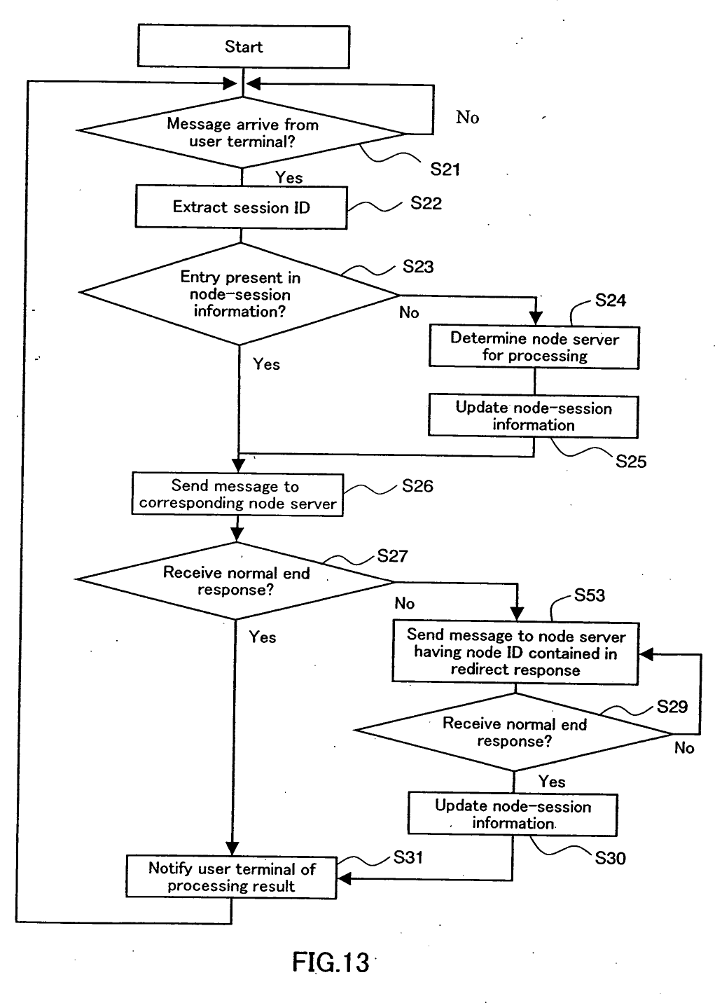

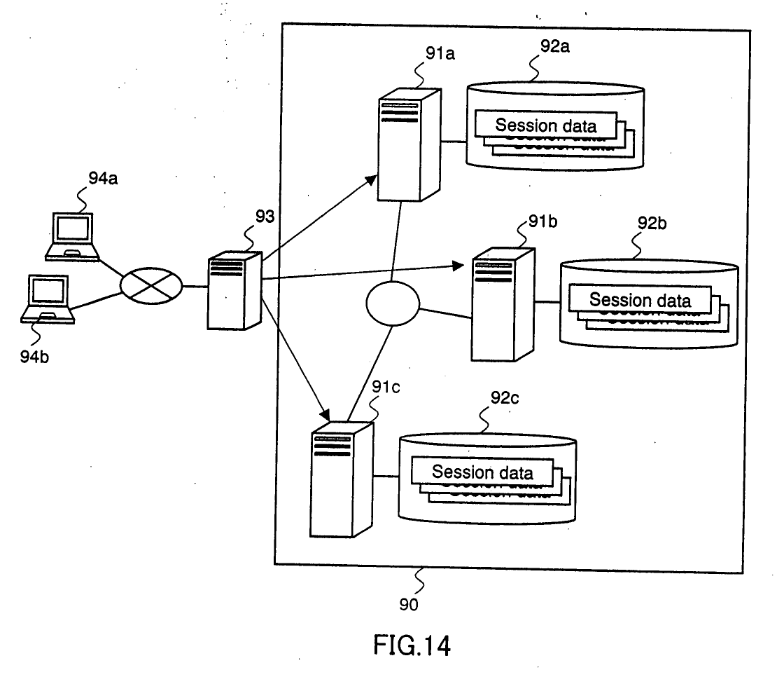

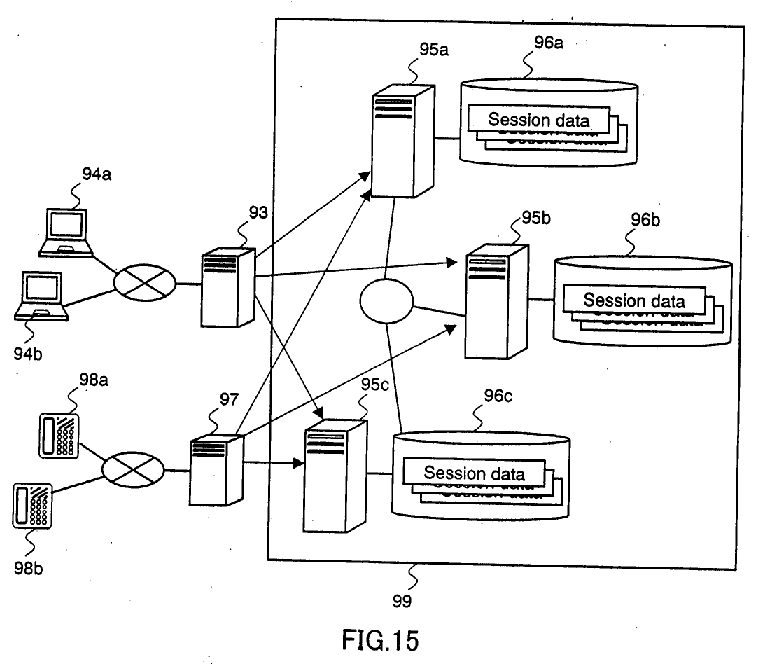

FIG. 13 is a flowchart showing an example of a processing in which the SIP load balancer 5b receives an SIP message from a user terminal 8a and sends the SIP message to the cluster system 1 in the present embodiment. The processing shown in FIG. 13 is different from that shown in FIG. 10 in Step S53.

In the case where the response to the SIP message sent to the node server contains a redirect instruction, the result of Step S27 is No. The SIP load balancer 5b resends the SIP message to the node server having the node ID contained in the redirect response (Step S53). Since the redirect response contains the node ID of a normally-functioning node server, the response to the resent SIP message is likely to end normally.

In this manner, for example, when the node server 2a receives the HTTP message from the HTTP load balancer 5a, the node server in charge of the integrated session is changed to an alternative node server in Step S51 in FIG. 12. At this time, the SIP load balancer 5b has not obtained information indicating that the node server in charge of that session was changed to the alternative node server. In this state, when the node server 2a receives the SIP message from the SIP load balancer 5b, the node ID of this alternative node server is contained in a redirect response and returned to the SIP load balancer 5b as a response (Step S52 in FIG. 12). As a result, the node server 2a can send the SIP load balancer 5b the redirect instruction to the alternative node server at the time of receiving the message from the SIP load balancer 5b. Thus, the session is operated efficiently.

The present invention can be utilized as a clustering system capable of processing messages from a plurality of load balancers efficiently even when a part of a plurality of node servers comes to a halt due to a failure or the like.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A cluster system comprising:
a plurality of node servers that are connected to a plurality of load balancers and process messages from a plurality of user terminals respectively accessing the plurality of load balancers so as to allow a data communication between the plurality of user terminals;
wherein each of the plurality of node servers is accessible to a storage portion storing node-session information that associates a session ID for identifying a session, which is a series of data communications conducted by a same user terminal, and a node server in charge for processing a message belonging to the session identified by the session ID with each other, and node life/death information that indicates whether or not each of the plurality of node servers is functioning normally, and
each of the plurality of node servers comprises
a node checking portion for, when receiving a message containing the session ID from any one of the plurality of load balancers, judging whether or not the node server in charge of the session identified by the session ID contained in the message is functioning normally using the node-session information and the node life/death information, and
a node reassigning portion for, if the node checking portion judges that the node server in charge of the session is not functioning normally, updating the node-session information so that the node server in charge of the session is changed to an alternative node server and sending data indicating the session and data indicating the alternative node server to the plurality of load balancers.

2. The cluster system according to claim 1, wherein, after an access regarding the session is made to the node server from a load balancer different from the load balancer that has sent the message, the node reassigning portion sends the session ID identifying the session and the data indicating the alternative node server to the load balancer that has made the access.

3. A cluster system comprising:
a plurality of node servers that are connected to a plurality of load balancers conducting data communications according to different communication protocols and process messages from a plurality of user terminals having different communication protocols respectively accessing the plurality of load balancers so as to allow the data communications between the plurality of user terminals having different communication protocols;
wherein each of the plurality of node servers is accessible to a storage portion storing node-session information that associates a session ID for identifying a session, which is a series of data communications conducted between user terminals having different communication protocols, and a node server in charge for conducting a processing regarding the session identified by the session ID with each other, and node life/death information that indicates whether or not each of the plurality of node servers is functioning normally, and
each of the plurality of node servers comprises
a node checking portion for, when receiving a message sent from any one of the plurality of load balancers, judging whether or not the node server in charge of the session to which the message belongs is functioning normally using the node-session information and the node life/death information, and
a node reassigning portion for, if the node checking portion judges that the node server in charge of the session is not functioning normally, updating the node-session information so that the node server in charge of the session is changed to an alternative node server and sending data indicating the session and data indicating the alternative node server to another load balancer having a different communication protocol from the load balancer that has sent the message.

4. The cluster system according to claim 3, wherein the plurality of load balancers comprise a load balancer for conducting a data communication according to an HTTP protocol and a load balancer for conducting a data communication according to an SIP protocol.

5. A load balancer, which is the load balancer connected to the cluster system according to claim 1, comprising:
a storage portion for storing node-session information that associates a session ID and a node server in charge for conducting a processing regarding a session identified by the session ID with each other;
a load distributing portion for receiving a message from the plurality of user terminals, acquiring the session ID from the message and assigning the message to a node server determined based on the session ID and the node-session information; and
an updating portion for, when the data indicating the session and the data indicating the alternative node server are sent from the node reassigning portion provided in the node server, updating the node-session information stored in the storage portion based on both the data that are sent.

6. A node reassigning method conducted by a plurality of node servers that are connected to a plurality of load balancers and process messages from a plurality of user terminals respectively accessing the plurality of load balancers so as to allow a data communication between the plurality of user terminals in a cluster system comprising the plurality of node servers, the method comprising:
an operation in which each of the plurality of node servers stores node-session information that associates a session ID for identifying a session, which is a series of data communications conducted by a same user terminal, and a node server in charge for conducting a processing regarding the session identified by the session ID with each other, and node life/death information that indicates whether or not each of the plurality of node servers is functioning normally;
a node checking operation in which, when receiving a message sent from any one of the plurality of load balancers, any one of the plurality of node servers judges whether or not the node server in charge of the session to which the message belongs is functioning normally using the node-session information and the node life/death information; and
a node reassigning operation in which, if the node server in charge of the session is judged not to be functioning normally in the node checking operation, the node server updates the node-session information so that the node server in charge of the session is changed to an alternative node server and sends data indicating the session and data indicating the alternative node server to the plurality of load balancers.

7. A recording medium storing a node reassigning program causing a plurality of node servers that are connected to a plurality of load balancers and process messages from a plurality of user terminals respectively accessing the plurality of load balancers so as to allow a data communication between the plurality of user terminals in a cluster system comprising the plurality of node servers to execute
a process of storing in a storage portion of the node server node-session information that associates a session ID for identifying a session, which is a series of data communications conducted by a same user terminal, and a node server in charge for conducting a processing regarding the session identified by the session ID with each other, and node life/death information that indicates whether or not each of the plurality of node servers is functioning normally;
a node checking process of, when receiving a message sent from any one of the plurality of load balancers, judging whether or not the node server in charge of the session to which the message belongs is functioning normally using the node-session information and the node life/death information; and
a node reassigning process of, if the node server in charge of the session is judged not to be functioning normally in the node checking process, updating the node-session information so that the node server in charge of the session is changed to an alternative node server and sending information indicating the session and data indicating the alternative node server to the plurality of load balancers.
